(19) United States
(12) Patent Application Publication
(10) Pub. No.: US 2026/0181581 A1
(43) Pub. Date: Jun. 25, 2026

(54) Support for Network Connection Selection

(71) Applicant: Telefonaktiebolaget LM Ericsson (publ), Stockholm (SE)

(72) Inventors: Fengpei Zhang, Guangdong Guangzhou (CN); Chunlan Wu, Guangdong Guangzhou (CN)

(21) Appl. No.: 19/126,873

(22) PCT Filed: Jan. 17, 2023
(86) PCT No.: PCT/CN2023/072615

§ 371 Date: May 2, 2025

(51) Int. Cl. H04W 64/00; H04L 67/12; H04W 48/18; H04W 76/14; H04W 88/04; H04W 88/06

(52) U.S. Cl. CPC H04W 64/00; H04L 67/12; H04W 48/18; H04W 76/14; H04W 88/04; H04W 88/06

(57) ABSTRACT

The present disclosure is related to methods and UEs for supporting network connection selection. A method at a second UE, which has multiple network connections, for network connection selection, comprises: receiving, from a first UE, a first message indicating a weak signal strength event for a first network connection of the first UE, wherein a second network connection of the second UE corresponds to the first network connection of the first UE; and determining whether one of the multiple network connections that is different from the second network connection is to be selected for communication.

### TECHNICAL FIELD

The present disclosure is related to the field of telecommunications, and in particular, to methods and User Equipments (UEs) for supporting network connection selection.

### BACKGROUND

Vehicle-to-Everything (V2X) is a new generation of wireless communication technologies that enables data exchanges between vehicles and everything in their surroundings. V2X supports unified connectivity between connected entities in a V2X environment, such as vehicles, roadside equipments, and mobile devices, allowing them to transmit information such as their current speeds, positions, directions, etc. and make intelligent decisions. The technology creates an Intelligent Transportation System (ITS), transforming the experience of drivers, pedestrians, and transit riders by creating a more comfortable and safer transportation environment. It also has much significance in improving traffic efficiency and reducing greenhouse gas emissions and accident rates.

Typically, V2X supports several types of communications:
Vehicle-to-Vehicle (V2V) covers communication between two or more vehicles;
Vehicle-to-Pedestrian (V2P) covers the connection between vehicles and roadside users;
Vehicle-to-Infrastructure (V2I) is the communication between road entities and infrastructure units; and
Vehicle-to-Network (V2N) is the communication between vehicles and a communication network.

An autonomous vehicle, or a driverless vehicle, is one that is able to operate itself and perform necessary functions without any human intervention, through ability to sense its surroundings. An autonomous vehicle utilizes a fully automated driving system in order to allow the vehicle to respond to external conditions that a human driver would manage. Therefore, in a typical scenario, an autonomous vehicle requires numerous data related to its surroundings (such as video data, LiDAR data, navigation data, map data, data related to traffic accidents, data related to road conditions, etc.) to make sure that it can drive safely and efficiently. Some of the data can be sensed or generated at the vehicle locally, while others have to be received from a communication network in real time. This network requirement becomes even more stringent for other scenarios, such as teleoperated vehicles, since data transmission in both directions for such a case is required, and such data transmission should be highly reliable while an extremely low network latency should be achieved.

### SUMMARY

Therefore, it is very important for a vehicle to receive and transmit the data robustly and efficiently. However, a single network connection may experience deteriorated network conditions from time to time, such as low throughput, high latency, or even worse, disconnection. Therefore, redundant network connections are required in such a case, and a solution for network connection selection is needed.

In order to address or at least partially alleviate the above issues, some embodiments of the present disclosure provide support for network connection selection.

According to a first aspect of the present disclosure, a method at a second UE, which has multiple network connections, for network connection selection is provided. The method comprises: receiving, from a first UE, a first message indicating a weak signal strength event for a first network connection of the first UE, wherein a second network connection of the second UE corresponds to the first network connection of the first UE; and determining whether one of the multiple network connections that is different from the second network connection is to be selected for communication.

In some embodiments, the first message is broadcasted by the first UE via V2V messaging over PC5. In some embodiments, the step of determining whether one of the multiple network connections that is different from the second network connection is to be selected for communication comprises at least one of: determining whether a location associated with the weak signal strength event is relevant to a route, along which the second UE is travelling, or not; and determining whether the second network connection is currently in use by the second UE or not.

In some embodiments, the step of determining whether one of the multiple network connections that is different from the second network connection is to be selected for communication further comprises at least one of: determining that one of the multiple network connections that is different from the second network connection is not to be selected for communication in response to determining that the location is not relevant to the route; determining that one of the multiple network connections that is different from the second network connection is not to be selected for communication in response to determining that the second network connection is not currently in use by the second UE; and determining that one of the multiple network connections that is different from the second network connection is to be selected for communication in response to determining that the location is relevant to the route and that the second network connection is currently in use by the second UE.

In some embodiments, the method further comprises: determining a distance between the current location of the second UE and a location indicated by the weak signal strength event in response to determining that one of the multiple network connections that is different from the second network connection is to be selected for communication. In some embodiments, the method further comprises: determining an estimated time of arrival (ETA) for the second UE to arrive at the location indicated by the weak signal strength event based on at least the determined distance. In some embodiments, the method further comprises at least one of: determining a first start time for a procedure to start preparing the selected network connection for communication based on at least the determined ETA; and determining a second start time to start using the selected network connection for communication based on at least the determined ETA. In some embodiments, the method further comprises at least one of: starting the procedure at the first start time; and starting using the selected network connection at the second start time.

In some embodiments, the procedure comprises at least one of: requesting for a Quality of Service (QoS) for the selected network connection; and steering traffic associated with the second UE to an Edge Application Server (EAS). In some embodiments, the step of receiving the first message comprises at least one of: receiving, from the first UE, the first message via the second network connection; receiving, from the first UE, the first message via the selected network connection; and receiving, from the first UE, the first message via at least one of the multiple network connections other than the second network connection and the selected network connection. In some embodiments, the weak signal strength event indicates one or more weak signal areas. In some embodiments, for each of the one or more weak signal areas, the weak signal strength event indicates at least one of: a location or location area where a weak signal is detected; an identity (ID) of a Communication Service Provider (CSP) for which the weak signal is detected; a Radio Access Type (RAT) associated with the detected weak signal; and a signal strength of the detected weak signal. In some embodiments, the first UE and the second UE are vehicles.

According to a second aspect of the present disclosure, a method at a first UE for weak signal strength detecting and reporting is provided. The method comprises: detecting whether the first UE has a first network connection with its signal strength lower than or equal to a threshold or not; and transmitting, to a second UE, a first message indicating a weak signal strength event for the first network connection in response to detecting that the first UE has the first network connection with its signal strength lower than or equal to the threshold.

In some embodiments, the second UE has multiple network connections comprising a second network connection corresponding to the first network connection of the first UE. In some embodiments, the step of transmitting the first message comprises: broadcasting the first message via V2V messaging over PC5. In some embodiments, the first message is broadcasted periodically. In some embodiments, the method further comprises: keeping detecting whether the first network connection has its signal strength lower than or equal to the threshold or not until it is detected that the first network connection has its signal strength higher than the threshold.

In some embodiments, the method further comprises: determining a distance between a first location and a second location, wherein the first location is a location where it is detected that the first network connection has its signal strength lower than or equal to the threshold, wherein the second location is a location where it is detected, after the detection at the first location, that the first network connection has its signal strength higher than the threshold. In some embodiments, the first location is a location where it is detected for the first time that the first network connection has its signal strength lower than or equal to the threshold.

In some embodiments, the second location is a location where it is detected for the first time, after the detection at the first location, that the first network connection has its signal strength higher than the threshold. In some embodiments, the method further comprises: comparing the distance against a maximum broadcasting distance associated with the first UE, wherein the step of transmitting the first message is performed only when the distance is shorter than or equal to the maximum broadcasting distance associated with the first UE.

In some embodiments, the first network connection is the only network connection that the first UE has. In some embodiments, the step of transmitting the first message is not performed until the first network connection has its signal strength higher than the threshold. In some embodiments, the method further comprises: caching one or more weak signal strength events in response to detecting that the first network connection has its signal strength lower than or equal to the threshold for one or more times until it is detected that the first network connection has its signal strength higher than the threshold. In some embodiments, the first UE has multiple network connections comprising at least the first network connection and a third network connection, wherein the second UE has a fourth network connection corresponding to the third network connection.

In some embodiments, the step of transmitting the first message comprises at least one of: transmitting, to the second UE, the first message via the third network connection when it is detected that the first network connection has its signal strength lower than or equal to the threshold; and transmitting, to the second UE, the first message via both of the first network connection and the third network connection when it is detected that the first network connection has its signal strength higher than the threshold. In some embodiments, the method further comprises: transmitting, to a server, a second message indicating the weak signal strength event for analytics purpose. In some embodiments, the weak signal strength event indicates one or more weak signal areas.

In some embodiments, for each of the one or more weak signal areas, the weak signal strength event indicates at least one of: a location or location area where a weak signal is detected; an ID of a CSP for which the weak signal is detected; an RAT associated with the detected weak signal; and a signal strength of the detected weak signal. In some embodiments, the first UE and the second UE are vehicles.

According to a third aspect of the present disclosure, a UE is provided. The UE comprises: a processor; a memory storing instructions which, when executed by the processor, cause the processor to perform any of the methods of any of the first and/or the second aspects.

According to a fourth aspect of the present disclosure, a second UE, which has multiple network connections, for network connection selection is provided. The second UE comprises: a receiving module configured to receive, from a first UE, a first message indicating a weak signal strength event for a first network connection of the first UE, wherein a second network connection of the second UE corresponds to the first network connection of the first UE; and a determining module configured to determine whether one of the multiple network connections that is different from the second network connection is to be selected for communication. In some embodiments, the second UE comprises one or more further modules, each of which may perform any of the steps of any of the methods of the first aspect.

According to a fifth aspect of the present disclosure, a first UE for weak signal strength detecting and reporting is provided. The first UE comprises: a detecting module configured to detect whether the first UE has a first network connection with its signal strength lower than or equal to a threshold or not; and a transmitting module configured to transmit, to a second UE, a first message indicating a weak signal strength event for the first network connection in response to detecting that the first UE has the first network connection with its signal strength lower than or equal to the threshold. In some embodiments, the first UE comprises one or more further modules, each of which may perform any of the steps of any of the methods of the second aspect.

According to a sixth aspect of the present disclosure, a computer program comprising instructions is provided. The instructions, when executed by at least one processor, cause the at least one processor to carry out any of the methods of the first and/or second aspects.

According to a seventh aspect of the present disclosure, a carrier containing the computer program of the sixth aspect is provided. In some embodiments, the carrier is one of an electronic signal, optical signal, radio signal, or computer readable storage medium.

According to an eighth aspect of the present disclosure, a telecommunications system is provided. The telecommunications system comprises: one or more first UEs, each of which comprises: a processor; a memory storing instructions which, when executed by the processor, cause the processor to perform any of the methods of the second aspect, one or more second UEs, each of which comprises: a processor; a memory storing instructions which, when executed by the processor, cause the processor to perform any of the methods of the first aspect.

With some embodiments of the present disclosure, service continuity for critical vehicles such as autonomous and teleoperated vehicles may be ensured, which means driving safety may be ensured also.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary interaction between a vehicle and a network node for which support for network connection selection is applicable according to an embodiment of the present disclosure.

FIG. 2 is a diagram illustrating an exemplary telecommunications system in which support for network connection selection is applicable according to an embodiment of the present disclosure.

FIG. 3 is a diagram illustrating an exemplary Cellular-V2X (C-V2X) telecommunications network in which support for network connection selection is applicable according to an embodiment of the present disclosure.

FIG. 4 is a diagram illustrating an exemplary scenario where a sending vehicle detects and reports a weak signal event to receiving vehicles for their network connection selection according to an embodiment of the present disclosure.

FIG. 5 is a flow chart illustrating an exemplary method for an exemplary sending vehicle shown in FIG. 4.

FIG. 6 is a diagram illustrating another exemplary scenario where a sending vehicle detects and reports a weak signal event to receiving vehicles for their network connection selection according to another embodiment of the present disclosure.

FIG. 7 is a flow chart illustrating an exemplary method for an exemplary sending vehicle shown in FIG. 6.

FIG. 8 is a diagram illustrating an exemplary scenario where a receiving vehicle makes a network connection selection based on a weak signal event received from a sending vehicle according to an embodiment of the present disclosure.

FIG. 9 is a flow chart illustrating an exemplary method for an exemplary receiving vehicle shown in FIG. 8.

FIG. 10A and FIG. 10B are diagrams illustrating exemplary scenarios where network connection selection is supported according to some embodiments of the present disclosure.

FIG. 11 is a flow chart illustrating an exemplary method at a second UE, which has multiple network connections, for network connection selection according to an embodiment of the present disclosure.

FIG. 12 is a flow chart illustrating an exemplary method at a first UE for weak signal strength detecting and reporting according to an embodiment of the present disclosure.

FIG. 13 schematically shows an embodiment of an arrangement which may be used in UEs according to an embodiment of the present disclosure.

FIG. 14 is a block diagram illustrating an exemplary second UE according to an embodiment of the present disclosure.

FIG. 15 is a block diagram illustrating an exemplary first UE according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as network connection selection are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “UE” used herein may refer to a terminal device, a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, or any other equivalents.

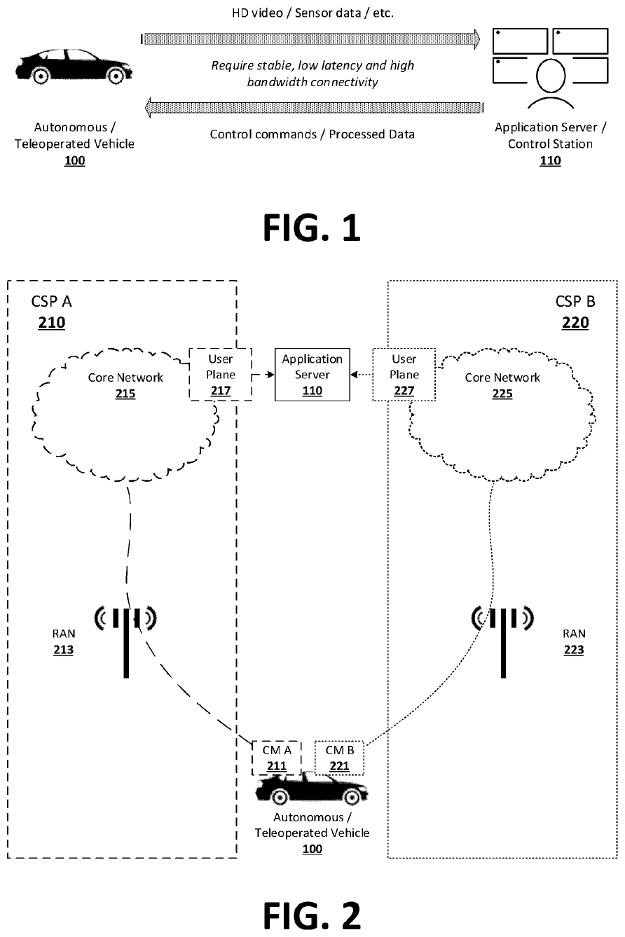

FIG. 1 is a diagram illustrating an exemplary interaction between a vehicle and a network node for which support for network connection selection is applicable according to an embodiment of the present disclosure. As shown in FIG. 1, a vehicle 100, such as an autonomous vehicle or a teleoperated vehicle, may communicate with an application server and/or a control station 110. For example, when the vehicle 100 is a teleoperated vehicle, it can provide High Definition (HD) video that it captures, sensor data (such as LIDAR data, vehicle speed, vehicle location, etc.), or the like to the control station 110, while the control station 110 may provide its control commands and/or other data (such as, an updated vehicle configuration, an upgraded vehicle firmware, or the like), such that an operator/driver may be enabled to remotely control the vehicle 100 as if he/she is in the vehicle while he/she is driving. Therefore, a very robust and efficient network connection between the vehicle 100 and the application server/control station 110 is required.

However, cellular network connectivity is dynamic by nature for several reasons:
Network design. Due to specific designs and deployments, such as antenna location, density, and transmission technology used, a good coverage for all places at all times is almost impossible.
Cellular networks rely on radio waves for transmission, which can be blocked or weakened by obstructions such as buildings or even cars and trucks. Modern cellular networks are designed to overcome such barriers and provide coverage without line-of-sight in most locations, yet the fact of the matter is that signal strength fluctuation and coverage is dynamic.
When in motion, a connection to the network is handed over from one base-station to another from time to time, and such a handover sometimes involves a drop in connectivity levels. By nature, a moving vehicle experiences frequent cell handovers as it enters and exits areas of reception of different base stations.
Other factors that impact the available bandwidth capacity include distance from the tower (antenna), the number of connections in a specific cell at any given time, and overall congestion in the backhaul, or the like.
Finally, network operators make tweaks and changes to the network on an ongoing basis, meaning that capacity can change unexpectedly even in locations that are known to have good connectivity.

For all the reasons described above, it is extremely hard to guarantee consistent, high-quality, and low-latency connectivity using a single network. Even if the desired level of connectivity is currently available, a change can occur-a tall building, cell handover, more users- and suddenly it is not enough. A sudden drop can cause a gap in reception, leading to a delay or even loss of data packets. That's why it is not safe to depend on one modem/one mobile network, even if it is 5G.

Therefore, a best practice of autonomous/teleoperated vehicles is to equip the vehicle with 2 communication modules (CMs) connecting to two mobile networks as redundancy, for example, as shown in FIG. 2. FIG. 2 is a diagram illustrating an exemplary telecommunications system in which support for network connection selection is applicable according to an embodiment of the present disclosure. As shown in FIG. 2, a vehicle 100 may have two or more CMs, such as, a CM A 211 served by a CSP A 210 and a CM B 221 served by another CSP B 220. As also shown in FIG. 2, the CSP A 210 may have a Radio Access Network (RAN) 213 and a core network 215 which may provide, together with the CM A 211, a user plane 217, such that the vehicle 100 may communicate with an application server 110 through the user plane 217 via the CM A 211, the RAN 213, and the core network 215. Similarly, the CSP B 220 may have a RAN 223 and a core network 225 which may provide, together with the CM B 221, a user plane 227, such that the vehicle 100 may communicate with the application server 110 through the user plane 227 via the CM B 221, the RAN 223, and the core network 225. In the telecommunications system shown in FIG. 2, the vehicle 100 may have more than one network connection and a more robust network connection can be achieved.

If the connection selection is based on the weak signal strength detected by the vehicle 100 itself, it may be too late. For example, the following scenarios may be considered:
If the vehicle 100 needs to apply additional QoS for the connection, it may also need to apply it for the redundant connection which will take time.
If the vehicle 100 needs to connect to the Edge Application Server, the vehicle 100 may need to discover/select a new Edge Application Server using the redundant connection and trigger Application Context Relocation; or need to influence the traffic to the same Edge Application Server based on the redundant connection; which will take time also.

In such scenarios, be aware of a weak signal strength area in advance will help the vehicle 100 with network redundancy to select the right connection to ensure service continuity and further ensure driving safety.

However, there is currently no prior art upon sharing weak signal information in real-time through V2V. The V2V messaging specifications such as DENM (Decentralized Environmental Notification Message) only defines events about weather, road and traffic conditions. However, as the network condition becomes an extremely critical part of a vehicle, sharing the network condition information among vehicles in real-time also becomes critical.

Therefore, some embodiments of the present disclosure introduce a method for vehicles to share weak signal strength information through V2V in real-time. In some embodiments, when a vehicle with network redundancy receives the weak signal strength information, it may determine potential connection selection to ensure service continuity and driving safety.

In some embodiments, a vehicle may share detected weak signal strength information through V2V messaging over PC5. In some embodiments, when a vehicle with network redundancy receives the weak signal strength information through V2V messaging over PC5, it may use the information to determine connection selection.

With some embodiments of the present disclosure, service continuity for critical vehicles such as autonomous and teleoperated vehicles may be ensured, which means driving safety may be ensured also.

As mentioned above, V2X is a technology that allows vehicles to communicate with any entity that may affect the vehicle, and vice versa. V2X may consist of more specific types of communication as V2I (vehicle-to-infrastructure), V2N (vehicle-to-network), V2V (vehicle-to-vehicle), V2P (vehicle-to-pedestrian) etc.

C-V2X allows a C-V2X device to use the cellular network connection in the traditional manner over Uu interface. Uu refers to the logical interface between a UE and a base station. This is generally referred to as V2N.

However, due to the huge amount of message exchanges especially for V2V communication, 3^{rd} Generation Partnership Project (3GPP) also introduces PC5 interface (also known as “slidelink” in 3GPP RAN specification) to support direct communication between C-V2X devices to improve the C-V2X efficiency.

V2X is also essential for safe and efficient autonomous driving. For example, V2X communication can alert the autonomous driving vehicle about objects it cannot directly see (non-line-of-sight).

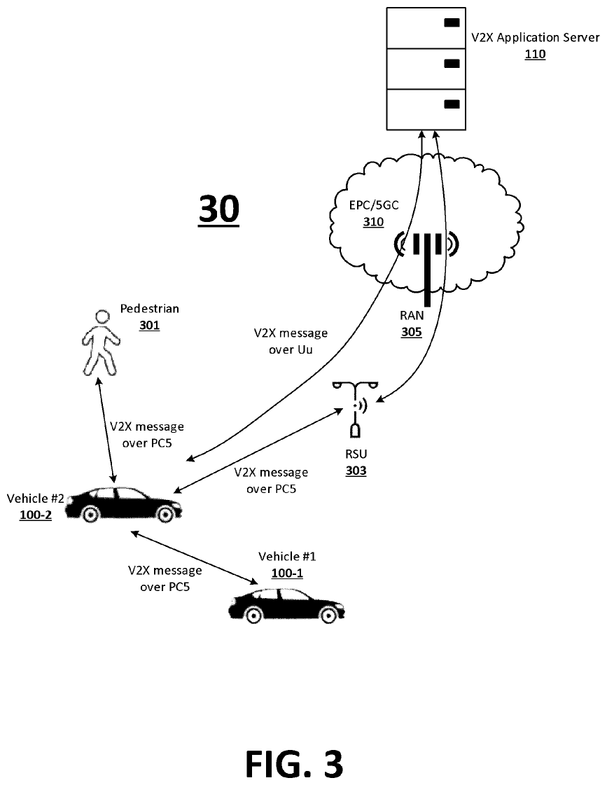

FIG. 3 is a diagram illustrating an exemplary C-V2X telecommunications network 30 in which support for network connection selection is applicable according to an embodiment of the present disclosure.

As shown in FIG. 3, the network 30 may comprise at least one of: one or more vehicles 100-1 and 100-2 (collectively, the vehicles 100), a pedestrian (and a UE attached to or carried by the pedestrian) 301, a Road Side Unit (RSU) 303, a RAN 305, a core network (e.g., an Evolved Packet Core (EPC) or a 5G Core (5GC)) 310, and a V2X application server 110. Please note that the present disclosure is not limited thereto. In some other embodiments, different numbers and/or different types of the entities may be present in the network 30. For example, the network 30 may comprise one or more of drones, lane markings, road signs, and traffic lights, or the like. Further, the term “UE” used herein may also refer to any of a vehicle, a pedestrian (or a device associated therewith), and an RSU shown in FIG. 3, or any other similar entity.

As shown in FIG. 3, a vehicle (e.g., the vehicle 100-2) may communicate with another vehicle (e.g., the vehicle 100-1) via V2V over the PC5 interface or reference point. As also shown in FIG. 3, a vehicle (e.g., the vehicle 100-2) may communicate with a pedestrian (e.g., the pedestrian 301) via V2P over the PC5 interface or reference point. As further shown in FIG. 3, a vehicle (e.g., the vehicle 100-2) may communicate with an RSU (e.g., the RSU 303) via V2I over the PC5 interface or reference point. As also shown in FIG. 3, an RSU (e.g., the RSU 303) may communicate with a RAN (e.g., the RAN 305) via V2N over the Uu interface or reference point. Further, other entities may communicate with each other in similar manners as described above. In other words, the UEs (e.g., the vehicles 100, the pedestrian 301, and/or the RSU 303) shown in FIG. 3 may communicate with each other via V2X over the PC5/Uu interface. In this way, a UE (e.g., the vehicle #1 100-1) in the network 30 may communicate with the V2X application server 110, for example, via the vehicle #2 100-2, the RSU 303, the RAN 305, and the EPC/5GC 310, and information, such as, vehicle information (e.g., speed, location, vehicle type, etc.), navigation information, traffic information, control commands, entertainment information, can be exchanged therebetween.

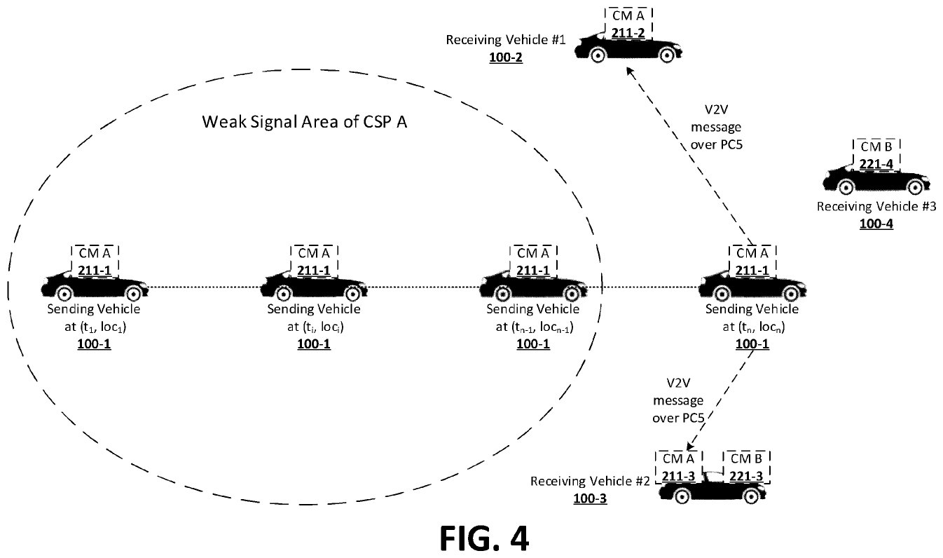

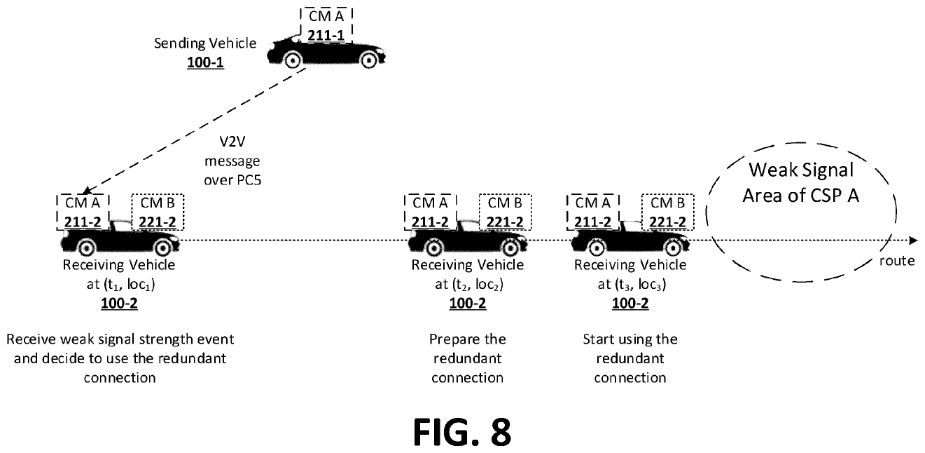

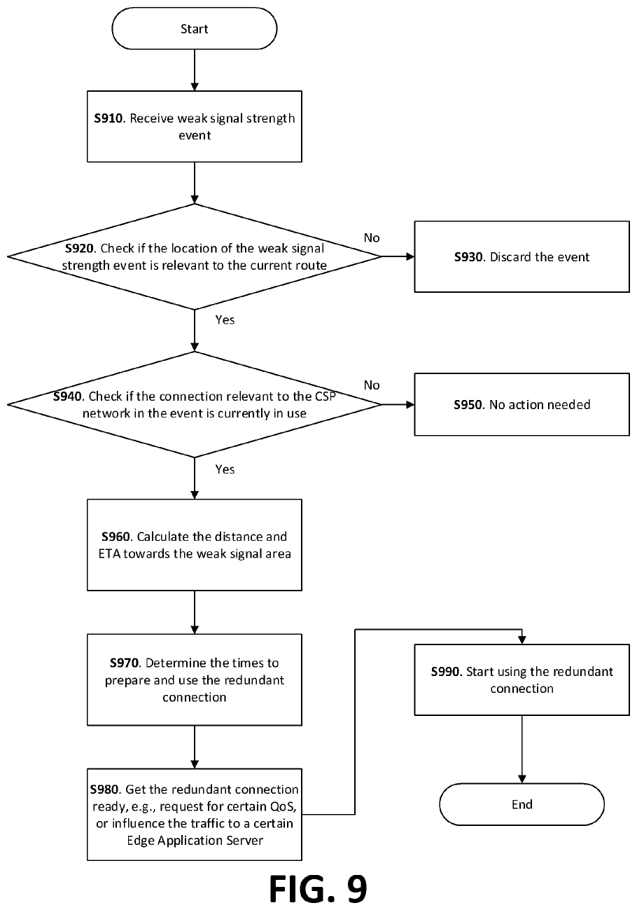

Some embodiments of the present disclosure introduce two main procedures:
A sending vehicle detects and broadcasts weak signal strength information through V2V messaging over PC5, which will be described in detail with reference to FIG. 4 through FIG. 7.
A receiving vehicle with network redundancy determines connection selection based on the received weak signal strength information through V2V messaging over PC5, which will be described in detail with reference to FIG. 8 and FIG. 9.

### Broadcast Weak Signal Strength Information Through V2V

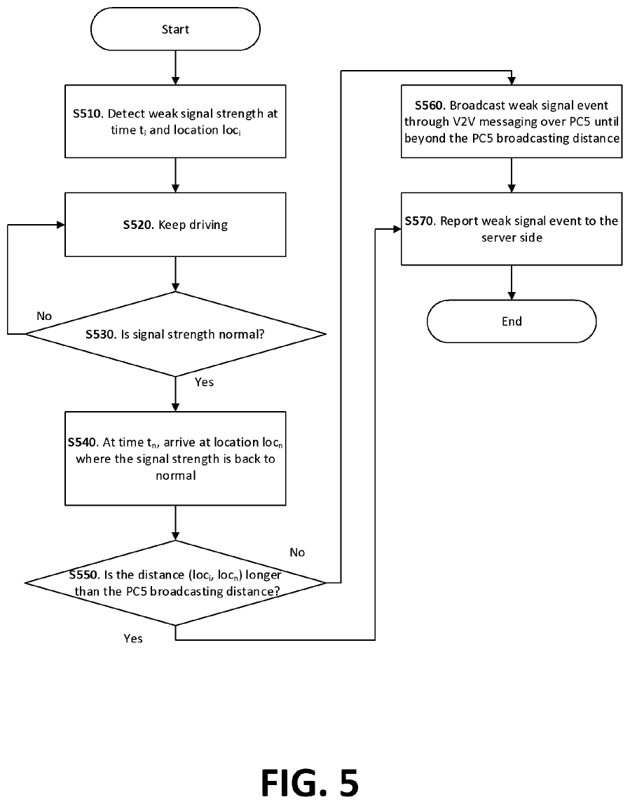

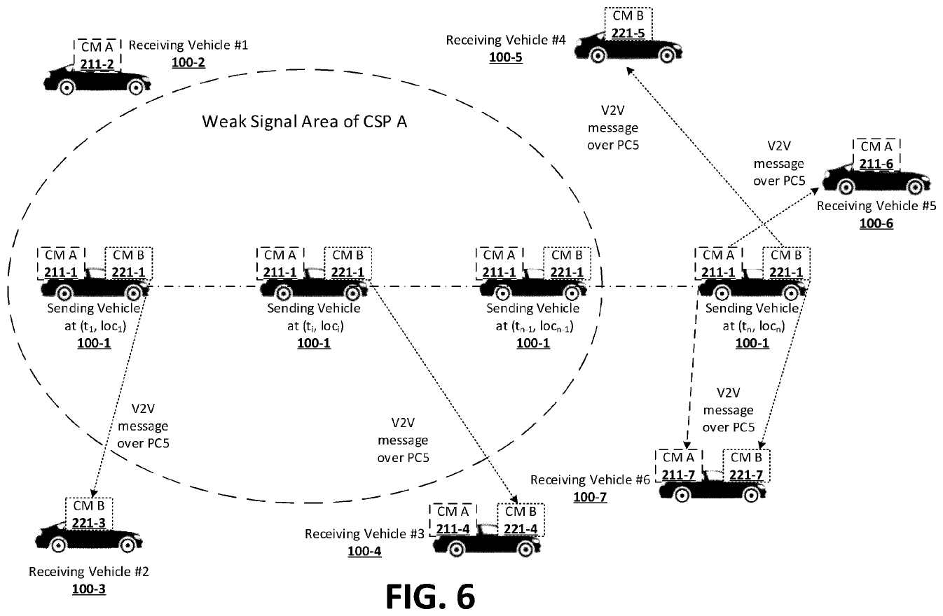

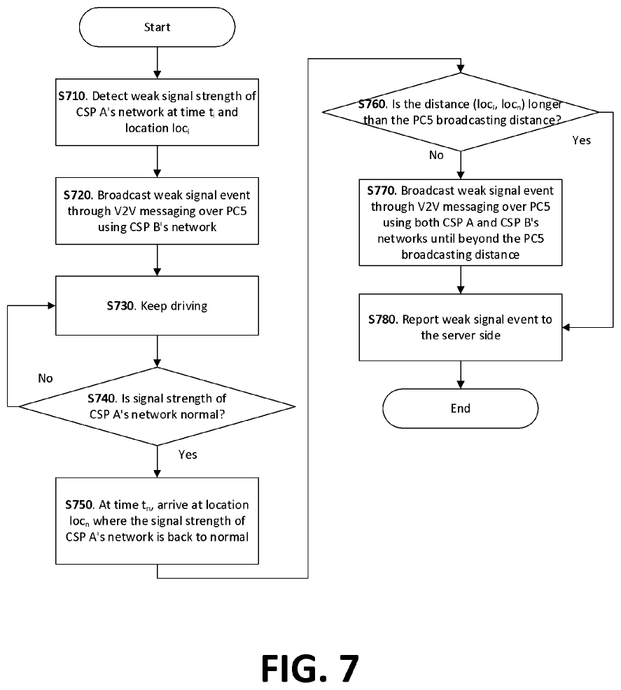

There are two scenarios where a vehicle can detect and broadcast weak signal strength information:
Scenario A: it may be the one without network redundancy, which will be described in detail with reference to FIG. 4 and FIG. 5; and
Scenario B: it may be the one with network redundancy, which will be described in detail with reference to FIG. 6 and FIG. 7.
   Sending Vehicle without Network Redundancy

FIG. 4 is a diagram illustrating an exemplary scenario where a sending vehicle detects and reports a weak signal event to receiving vehicles for their network connection selection according to an embodiment of the present disclosure. FIG. 5 is a flow chart illustrating an exemplary method for an exemplary sending vehicle shown in FIG. 4.

As shown in FIG. 4, a vehicle (or known as “sending vehicle” hereinafter) 100-1 may have only one network connection which is provided by a CSP A through an associated CM A 211-1 installed on the vehicle 100-1. The sending vehicle 100-1 may travel along its route and enter into a weak signal area of CSP A. Next, an exemplary method at the sending vehicle 100-1 will be described in detail with reference to FIG. 4 and FIG. 5.

The method may begin with step S510 where the vehicle 100-1 may detect a weak signal strength at time tᵢ and location locᵢ. For example, as shown in FIG. 4, the sending vehicle 100-1 may detect a weak signal strength for its network connection provided by the CSP A at time t₁ and location loc₁, for example, upon entering into the weak signal area. Since the network signal strength is weak, the sending vehicle 100-1 may not be able to broadcast the weak signal event right away. Therefore, in some embodiments, the sending vehicle 100-1 may cache the event and keeps driving at step S520.

At step S530, the sending vehicle 100-1 may keep detecting the signal strength while driving, and the sending vehicle 100-1 may cache more weak signal events until the signal strength is back to normal. For example, as shown in FIG. 4, the sending vehicle 100-1 may detect a weak signal strength at time tᵢ and location locᵢ in the middle of the weak signal area and a weak signal strength at time tₙ₋₁ and location locₙ₋₁ just before exiting the weak signal area.

At step S540, the sending vehicle 100-1 may detect that signal strength is back to normal at time tₙ and location locₙ, for example, after it exits the weak signal area.

In some embodiments, if a distance between loc; and locₙ is longer than a preconfigured PC5 broadcasting distance (e.g., maxBcDist), which means that the surrounding vehicles may not be relevant to the previously detected weak signal strength event, the sending vehicle 100-1 will only send the event to the server side for data analytics purpose. Therefore, at step S550, the sending vehicle 100-1 may determine whether the distance between locᵢ and locₙ is longer than a preconfigured PC5 broadcasting distance, for i=1, . . . , n−1. When the distance is longer than the preconfigured PC5 broadcasting distance (“Yes” at step S550), the method may proceed to step S570 where the weak signal event may be reported to the server side. Otherwise, the method proceed to step S560 where the sending vehicle 100-1 may periodically broadcast the weak signal strength event through V2V messaging over PC5 until the distance between its current location and locᵢ is longer than maxBcDist. Further, in some embodiments, even under the condition of step S560, the sending vehicle 100-1 may also send the event to the server side for data analytics purpose at step S570.

As shown in FIG. 4, when the sending vehicle 100-1 broadcasts the weak signal event, any vehicle (or known as “receiving vehicle” hereinafter) that has a network connection provided by the CSP A may receive the weak signal event. For example, a receiving vehicle #1 100-2, which has a CM A 211-2 only, and a receiving vehicle #2 100-3, which has both a CM A 211-3 and a CM B 221-3, may receive the weak signal event. However, any vehicle that does not has a network connection provided by the CSP A (for example, a receiving vehicle #3 100-4, which has a CM B 221-4 only) cannot receive such an event.

Sending Vehicle with Network Redundancy

FIG. 6 is a diagram illustrating another exemplary scenario where a sending vehicle detects and reports a weak signal event to receiving vehicles for their network connection selection according to another embodiment of the present disclosure. FIG. 7 is a flow chart illustrating an exemplary method for an exemplary sending vehicle shown in FIG. 6.

As shown in FIG. 6, a sending vehicle 100-1 may have more than one network connection provided by the CSP A and CSP B through associated CM A 211-1 and CM B 221-1 installed on the vehicle 100-1. Similar to FIG. 4, the sending vehicle 100-1 may travel along its route and enter into a weak signal area of CSP A. Next, an exemplary method at the sending vehicle 100-1 will be described in detail with reference to FIG. 6 and FIG. 7.

The method may begin with step S710 where the vehicle 100-1 may detect a weak signal strength at time t₁ and location locᵢ. For example, as shown in FIG. 6, the sending vehicle 100-1 may detect a weak signal strength for its network connection provided by the CSP A at time t₁ and location loc₁, for example, upon entering into the weak signal area.

Since the network signal strength is weak, the sending vehicle 100-1 may not be able to broadcast the weak signal event now using the CSP A's network. However, at step S720, the sending vehicle 100-1 can still broadcast the event using CSP B's network, that is, through the CM B 221-1. For example, the sending vehicle may broadcast the weak signal event detected at time t₁ to a receiving vehicle #2 100-3, and broadcast the weak signal event detected at time t₁ to a receiving vehicle #3 100-4. On the other hand, any receiving vehicle that does not has a network connection provided by the CSP B (e.g., a receiving vehicle #1 100-2 that has a CM A 211-2 only) cannot receive any event reported by the sending vehicle 100-1 while the sending vehicle 100-1's network connection provided by the CSP A does not work. Further, in some embodiments, the sending vehicle 100-1 may or may not cache the event since the event is already reported to some other UEs.

At step S730, the sending vehicle 100-1 may keep driving.

At step S740, the sending vehicle 100-1 may keep detecting the signal strength of CSP A's network while driving. In some embodiments, the sending vehicle 100-1 may detect more weak signal events until the signal strength of CSP A's is back to normal. For example, as shown in FIG. 4, the sending vehicle 100-1 may detect a weak signal strength at time t, and location locᵢ in the middle of the weak signal area and a weak signal strength at time tₙ₋₁ and location locₙ₋₁ just before exiting the weak signal area. Further, in some embodiments, the sending vehicle 100-1 may cache more weak signal events until the signal strength of CSP A's network is back to normal.

At step S750, the sending vehicle 100-1 may detect that signal strength of CSP A's network is back to normal at time tₙ and location locₙ, for example, after it exits the weak signal area.

In some embodiments, if a distance between locᵢ and locₙ is longer than a preconfigured PC5 broadcasting distance (e.g., maxBcDist), which means that the surrounding vehicles may not be relevant to the previously detected weak signal strength event, the sending vehicle 100-1 will only send the event to the server side for data analytics purpose. Therefore, at step S760, the sending vehicle 100-1 may determine whether the distance between locᵢ and locₙ is longer than a preconfigured PC5 broadcasting distance, for i=1, . . . , n−1. When the distance is longer than the preconfigured PC5 broadcasting distance (“Yes” at step S760), the method may proceed to step S780 where the weak signal event may be reported to the server side. Otherwise, the method proceed to step S770 where the sending vehicle 100-1 may periodically broadcast the weak signal strength event through V2V messaging over PC5 using both CSP A and CSP B's networks until the distance between its current location and locᵢ is longer than maxBcDist. Further, in some embodiments, even under the condition of step S770, the sending vehicle 100-1 may also send the event to the server side for data analytics purpose at step S780.

As shown in FIG. 7, when the sending vehicle 100-1 broadcasts the weak signal event by using CSP A's network, any receiving vehicle that has a network connection provided by the CSP A may receive the weak signal event. Further, when the sending vehicle 100-1 broadcasts the weak signal event by using CSP B's network, any receiving vehicle that has a network connection provided by the CSP B may receive the weak signal event. For example, a receiving vehicle #4 100-5 having a CM B 221-5 only, a receiving vehicle #5 100-6 having a CM A 211-6 only, and a receiving vehicle #6 100-7 having both a CM A 211-7 and a CM B 221-7, may receive the weak signal event. However, any vehicle that does not has a network connection provided by the CSP A or the CSP B cannot receive such an event.

Although embodiments in which two CSPs are involved are described above, the present disclosure is not limited thereto. In some other embodiments, more than two CSPs may be involved, and the sending vehicle 100-1 and the receiving vehicles 100-2 through 100-7 may have one or more network connections provided by the more than two CSPs.

Further, in some embodiments, a weak signal event may be kept being broadcasted periodically until the sending vehicle 100-1 is away from the location where the weak signal event is detected by more than a threshold distance. For example, the event detected at loc₁ may be broadcasted periodically for multiple times until the sending vehicle is separated from the loc₁ by a threshold distance (e.g., the maximum PC5 broadcasting distance). That is to say, the sending vehicle 100-1 may broadcast multiple events (e.g., the events detected at loc₁, locᵢ, . . . locₙ₋₁) at a same time (e.g., at tₙ).

### Connection Selection Based on Weak Signal Strength Information

FIG. 8 is a diagram illustrating an exemplary scenario where a receiving vehicle 100-2 makes a network connection selection based on a weak signal event received from a sending vehicle 100-1 according to an embodiment of the present disclosure. FIG. 9 is a flow chart illustrating an exemplary method for an exemplary receiving vehicle 100-2 shown in FIG. 8.

The method may begin at step S910 where the receiving vehicle 100-2 may receive a weak signal strength event from the sending vehicle 100-1 at time t₁.

At step S920, the receiving vehicle 100-2 may check if the location inside the event is relevant to its driving route or not. If no, then it may discard the event at step S930. If yes, the receiving vehicle 100-2 may further check if the connection relevant to the CSP network reported by the event is currently in use or not at step S940. If no, then no action is needed at step S950. If yes, the receiving vehicle 100-2 may calculate the distance between current location and the weak signal strength area, and may further calculate the ETA for arriving at the weak signal strength area at step S960.

At step S970, the receiving vehicle 100-2 may determine the time t₂ when it starts preparing the redundant connection and the time t₃ when it starts using the redundant connection, for example, as shown in FIG. 8.

At step S980, the receiving vehicle 100-2 may start preparing the redundant connection at time t₂. For instance, the receiving vehicle 100-2 may request for certain QoS or steer the traffic towards a certain Edge Application Server.

At step S990, the receiving vehicle 100-2 may start using the redundant connection time t₃.

With the embodiments described with reference to FIG. 4 through FIG. 9, service continuity for critical vehicles such as autonomous and teleoperated vehicles may be ensured, which means driving safety may be ensured also.

In some embodiments, an exemplary weak signal strength event is provided in Table 1 below.

TABLE 1
Weak Signal Strength Event

| Information | |
|---|---|
| element | Description |
| List of Weak Signal | List of weak signal areas |
| Areas | |
| > Location | Location or location area where weak signal |
| | strength is detected. |
| > CSP ID | Identity of the CSP whose network signal is weak. |
| > Radio Access | The radio access type of the weak signal, e.g., |
| Type | 5G or 4G. |
| > Signal Strength | The received signal strength. |

However, the present disclosure is not limited thereto. In some other embodiment, more, less, and/or different Information Elements (IE) may be included in the event.

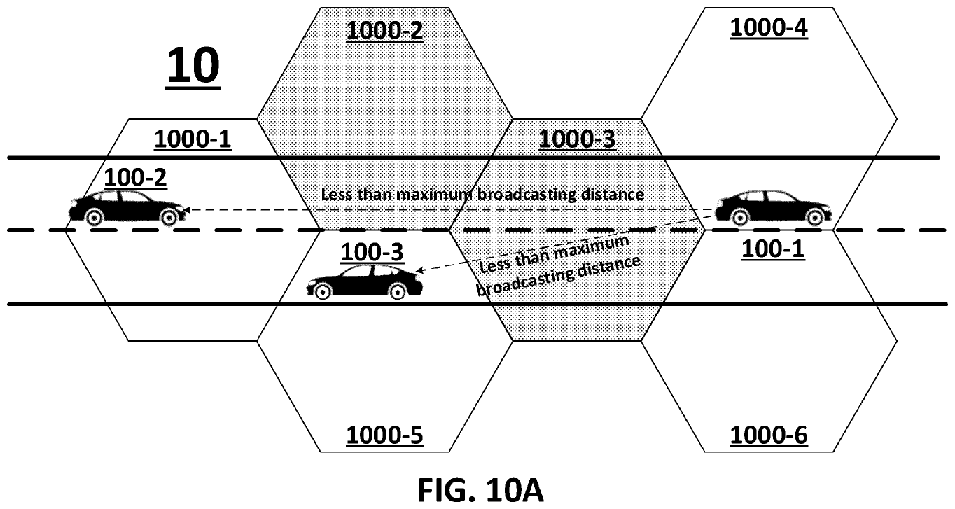

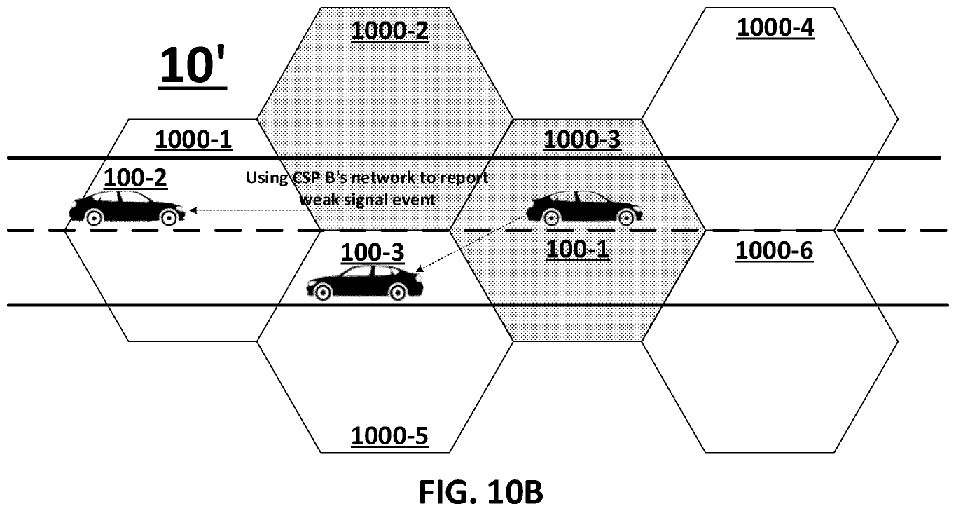

FIG. 10A and FIG. 10B are diagrams illustrating exemplary scenarios where network connection selection is supported according to some embodiments of the present disclosure. As shown in FIG. 10A, a vehicle 100-1 is driving along a road, which is covered by multiple cells 1000-1 through 1000-6, all of which are served by a CSP A. However, due to some unexpected condition, such as base station down or power outage, the cells 1000-2 and 1000-3 cannot provide any UE therein with good network connections. In such a case, when the vehicle 100-1 is driving through the cells 1000-2 and 1000-3, it may detect one or more weak signal strength events. Since the vehicle 100-1 has only a network connection to the CSP A, it cannot report the events when it is located in the cells 1000-2 and 1000-3. When it exits the weak signal area (including the cells 1000-2 and 1000-3) it may detect that the signal strength is back to normal, and then it may broadcast the one or more weak signal strength events to nearby vehicles, such as a vehicle 100-2 travelling in a same direction as that for the vehicle 100-1 and a vehicle 100-3 travelling in an opposite direction to that for the vehicle 100-1.

When the vehicle 100-2 receives the event, it may determine that this event is relevant to its route since it is travelling towards the weak signal area, and that the affected network connection is in use since it is currently using the CSP A's network. Therefore, the vehicle 100-2 may determine a time for preparing a network connection to CSP B and another time for using the network connection to CSP B, as described with reference to FIG. 8 and FIG. 9.

On the other hand, when the vehicle 100-3 receives the event, it may determine that this event is not relevant to its route since it is travelling away from the weak signal area, and it may discard the event, as described with reference to FIG. 8 and FIG. 9.

The embodiment shown in FIG. 10B is similar to that shown in FIG. 10A except that the vehicle 100-1 has more than one network connection. For example, the vehicle 100-1 may have a network connection to CSP A and another network connection to CSP B. In such a case, when it detects a weak signal strength event for CSP A, it may broadcast the event immediately by using the CSP B's network to nearby vehicles. In such a case, the nearby vehicles may become aware of the weak signal area early as long as they have a network connection to the CSP B's network.

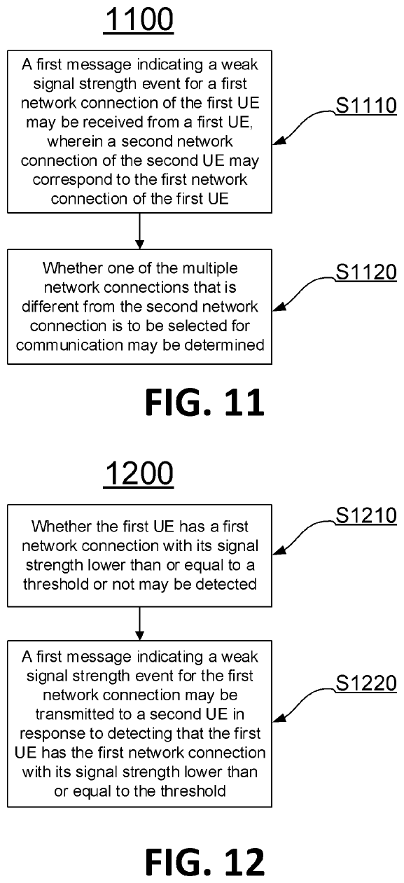

FIG. 11 is a flow chart of an exemplary method 1100 at a second UE, which has multiple network connections, for network connection selection according to an embodiment of the present disclosure. The method 1100 may be performed at a UE (e.g., the vehicle 100-2 shown in FIG. 8). The method 1100 may comprise steps S1110 and S1120. However, the present disclosure is not limited thereto. In some other embodiments, the method 1100 may comprise more steps, less steps, different steps, or any combination thereof. Further the steps of the method 1100 may be performed in a different order than that described herein. Further, in some embodiments, a step in the method 1100 may be split into multiple sub-steps and performed by different entities, and/or multiple steps in the method 1100 may be combined into a single step.

The method 1100 may begin at step S1110 where a first message indicating a weak signal strength event for a first network connection of the first UE may be received from a first UE. In some embodiments, a second network connection of the second UE may correspond to the first network connection of the first UE.

At step S1120, whether one of the multiple network connections that is different from the second network connection is to be selected for communication may be determined.

In some embodiments, the first message may be broadcasted by the first UE via V2V messaging over PC5. In some embodiments, the step of determining whether one of the multiple network connections that is different from the second network connection is to be selected for communication may comprise at least one of: determining whether a location associated with the weak signal strength event is relevant to a route, along which the second UE is travelling, or not; and determining whether the second network connection is currently in use by the second UE or not.

In some embodiments, the step of determining whether one of the multiple network connections that is different from the second network connection is to be selected for communication may further comprise at least one of: determining that one of the multiple network connections that is different from the second network connection is not to be selected for communication in response to determining that the location is not relevant to the route; determining that one of the multiple network connections that is different from the second network connection is not to be selected for communication in response to determining that the second network connection is not currently in use by the second UE; and determining that one of the multiple network connections that is different from the second network connection is to be selected for communication in response to determining that the location is relevant to the route and that the second network connection is currently in use by the second UE.

In some embodiments, the method 1100 may further comprise: determining a distance between the current location of the second UE and a location indicated by the weak signal strength event in response to determining that one of the multiple network connections that is different from the second network connection is to be selected for communication. In some embodiments, the method 1100 may further comprise: determining an ETA for the second UE to arrive at the location indicated by the weak signal strength event based on at least the determined distance. In some embodiments, the method 1100 may further comprise at least one of: determining a first start time for a procedure to start preparing the selected network connection for communication based on at least the determined ETA; and determining a second start time to start using the selected network connection for communication based on at least the determined ETA. In some embodiments, the method 1100 may further comprise at least one of: starting the procedure at the first start time; and starting using the selected network connection at the second start time.

In some embodiments, the procedure may comprise at least one of: requesting for a QoS for the selected network connection; and steering traffic associated with the second UE to an EAS. In some embodiments, the step of receiving the first message may comprise at least one of: receiving, from the first UE, the first message via the second network connection; receiving, from the first UE, the first message via the selected network connection; and receiving, from the first UE, the first message via at least one of the multiple network connections other than the second network connection and the selected network connection. In some embodiments, the weak signal strength event may indicate one or more weak signal areas. In some embodiments, for each of the one or more weak signal areas, the weak signal strength event may indicate at least one of: a location or location area where a weak signal is detected; an ID of a CSP for which the weak signal is detected; an RAT associated with the detected weak signal; and a signal strength of the detected weak signal. In some embodiments, the first UE and the second UE are vehicles.

FIG. 12 is a flow chart of an exemplary method 1200 at a first UE for weak signal strength detecting and reporting according to an embodiment of the present disclosure. The method 1200 may be performed at a UE (e.g., the vehicle 100-1 shown in FIG. 4 and/or FIG. 6). The method 1200 may comprise steps S1210 and S1220. However, the present disclosure is not limited thereto. In some other embodiments, the method 1200 may comprise more steps, less steps, different steps, or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin at step S1210 where whether the first UE has a first network connection with its signal strength lower than or equal to a threshold or not may be detected.

At step S1220, a first message indicating a weak signal strength event for the first network connection may be transmitted to a second UE in response to detecting that the first UE has the first network connection with its signal strength lower than or equal to the threshold.

In some embodiments, the second UE may have multiple network connections comprising a second network connection corresponding to the first network connection of the first UE. In some embodiments, the step of transmitting the first message may comprise: broadcasting the first message via V2V messaging over PC5. In some embodiments, the first message may be broadcasted periodically. In some embodiments, the method 1200 may further comprise: keeping detecting whether the first network connection has its signal strength lower than or equal to the threshold or not until it is detected that the first network connection has its signal strength higher than the threshold.

In some embodiments, the method 1200 may further comprise: determining a distance between a first location and a second location, wherein the first location may be a location where it is detected that the first network connection has its signal strength lower than or equal to the threshold, wherein the second location may be a location where it is detected, after the detection at the first location, that the first network connection has its signal strength higher than the threshold. In some embodiments, the first location may be a location where it is detected for the first time that the first network connection has its signal strength lower than or equal to the threshold.

In some embodiments, the second location may be a location where it is detected for the first time, after the detection at the first location, that the first network connection has its signal strength higher than the threshold. In some embodiments, the method 1200 may further comprise: comparing the distance against a maximum broadcasting distance associated with the first UE, wherein the step of transmitting the first message may be performed only when the distance is shorter than or equal to the maximum broadcasting distance associated with the first UE.

In some embodiments, the first network connection may be the only network connection that the first UE has. In some embodiments, the step of transmitting the first message may be not performed until the first network connection has its signal strength higher than the threshold. In some embodiments, the method 1200 may further comprise: caching one or more weak signal strength events in response to detecting that the first network connection has its signal strength lower than or equal to the threshold for one or more times until it is detected that the first network connection has its signal strength higher than the threshold. In some embodiments, the first UE may have multiple network connections comprising at least the first network connection and a third network connection, wherein the second UE has a fourth network connection corresponding to the third network connection.

In some embodiments, the step of transmitting the first message may comprise at least one of: transmitting, to the second UE, the first message via the third network connection when it is detected that the first network connection has its signal strength lower than or equal to the threshold; and transmitting, to the second UE, the first message via both of the first network connection and the third network connection when it is detected that the first network connection has its signal strength higher than the threshold. In some embodiments, the method 1200 may further comprise: transmitting, to a server, a second message indicating the weak signal strength event for analytics purpose. In some embodiments, the weak signal strength event may indicate one or more weak signal areas.

In some embodiments, for each of the one or more weak signal areas, the weak signal strength event may indicate at least one of: a location or location area where a weak signal is detected; an ID of a CSP for which the weak signal is detected; an RAT associated with the detected weak signal; and a signal strength of the detected weak signal. In some embodiments, the first UE and the second UE may be vehicles.

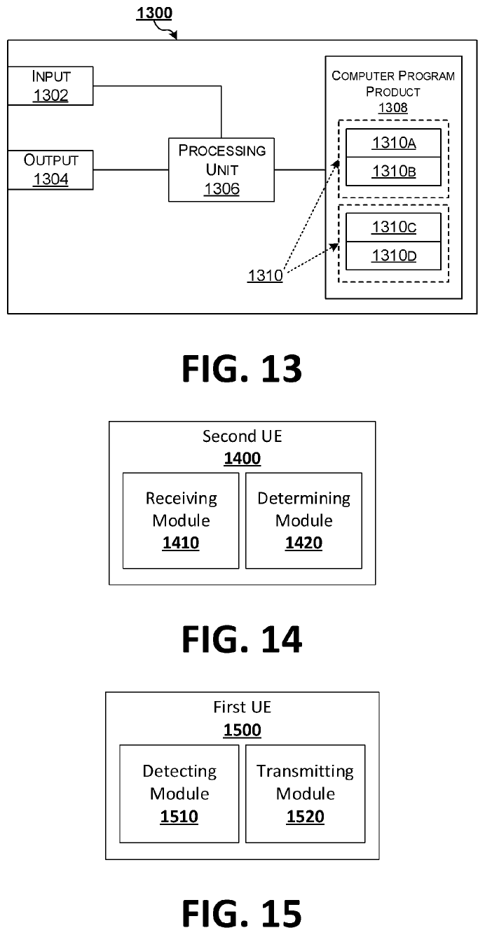

FIG. 13 schematically shows an embodiment of an arrangement which may be used in UEs according to an embodiment of the present disclosure. Comprised in the arrangement 1300 are a processing unit 1306, e.g., with a Digital Signal Processor (DSP) or a Central Processing Unit (CPU). The processing unit 1306 may be a single unit or a plurality of units to perform different actions of procedures described herein. The arrangement 1300 may also comprise an input unit 1302 for receiving signals from other entities, and an output unit 1304 for providing signal(s) to other entities. The input unit 1302 and the output unit 1304 may be arranged as an integrated entity or as separate entities.

Furthermore, the arrangement 1300 may comprise at least one computer program product 1308 in the form of a non-volatile or volatile memory, e.g., an Electrically Erasable Programmable Read-Only Memory (EEPROM), a flash memory and/or a hard drive. The computer program product 1308 comprises a computer program 1310, which comprises code/computer readable instructions, which when executed by the processing unit 1306 in the arrangement 1300 causes the arrangement 1300 and/or the UEs in which it is comprised to perform the actions, e.g., of the procedure described earlier in conjunction with FIG. 4 through FIG. 12 or any other variant.

The computer program 1310 may be configured as a computer program code structured in computer program modules 1310A to 1310B. Hence, in an exemplifying embodiment when the arrangement 1300 is used in a second UE, which has multiple network connections, for network connection selection, the code in the computer program of the arrangement 1300 includes: a module 1310A configured to receive, from a first UE, a first message indicating a weak signal strength event for a first network connection of the first UE, wherein a second network connection of the second UE may correspond to the first network connection of the first UE; and a module 1310B configured to determine whether one of the multiple network connections that is different from the second network connection is to be selected for communication.

Additionally or alternatively, the computer program 1310 may be further configured as a computer program code structured in computer program modules 1310C to 1310D. Hence, in an exemplifying embodiment when the arrangement 1300 is used in a first UE for weak signal strength detecting and reporting, the code in the computer program of the arrangement 1300 includes: a module 1310C configured to detect whether the first UE has a first network connection with its signal strength lower than or equal to a threshold or not; and a module 1310D configured to transmit, to a second UE, a first message indicating a weak signal strength event for the first network connection in response to detecting that the first UE has the first network connection with its signal strength lower than or equal to the threshold.

The computer program modules could essentially perform the actions of the flow illustrated in FIG. 4 through FIG. 12, to emulate the UEs. In other words, when the different computer program modules are executed in the processing unit 1306, they may correspond to different modules in the UEs.

Although the code means in the embodiments disclosed above in conjunction with FIG. 13 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

Correspondingly to the method 1100 as described above, an exemplary second UE, which has multiple network connections, for network connection selection is provided. FIG. 14 is a block diagram of an exemplary second UE 1400 according to an embodiment of the present disclosure. The second UE 1400 may be, e.g., the vehicle 100-2 in some embodiments.

The second UE 1400 may be configured to perform the method 1100 as described above in connection with FIG. 11. As shown in FIG. 14, the second UE 1400 may comprise a receiving module 1410 configured to receive, from a first UE, a first message indicating a weak signal strength event for a first network connection of the first UE, wherein a second network connection of the second UE may correspond to the first network connection of the first UE; and a determining module 1420 configured to determine whether one of the multiple network connections that is different from the second network connection is to be selected for communication.

The above modules 1410 and/or 1420 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 11. Further, the second UE 1400 may comprise one or more further modules, each of which may perform any of the steps of the method 1100 described with reference to FIG. 11.

Correspondingly to the method 1200 as described above, an exemplary first UE for weak signal strength detecting and reporting is provided. FIG. 15 is a block diagram of an exemplary first UE 1500 according to an embodiment of the present disclosure. The first UE 1500 may be, e.g., the vehicle 100-1 in some embodiments.

The first UE 1500 may be configured to perform the method 1200 as described above in connection with FIG. 12. As shown in FIG. 15, the first UE 1500 may comprise a detecting module 1510 configured to detect whether the first UE has a first network connection with its signal strength lower than or equal to a threshold or not; and a transmitting module 1520 configured to transmit, to a second UE, a first message indicating a weak signal strength event for the first network connection in response to detecting that the first UE has the first network connection with its signal strength lower than or equal to the threshold.

The above modules 1510 and/or 1520 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 12. Further, the first UE 1500 may comprise one or more further modules, each of which may perform any of the steps of the method 1200 described with reference to FIG. 12.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| C-V2X | Cellular Vehicle-to-Everything |
| CM | Communication Module |
| DENM | Decentralized Environmental Notification Message |
| ETA | Estimated Time of Arrival |
| ITS | Intelligent Transport System |
| V2I | Vehicle-to-Infrastructure |
| V2N | Vehicle-to-Network |
| V2P | Vehicle-to-Pedestrian |
| V2V | Vehicle-to-Vehicle |
| V2X | Vehicle-to-Everything |
| UE | User Equipment |

1-35. (canceled)

36. A method for network connection selection at a second User Equipment (UE) that has multiple network connections, the method comprising:
receiving, from a first UE, a first message indicating a weak signal strength event for a first network connection of the first UE, wherein a second network connection of the second UE corresponds to the first network connection of the first UE; and
determining whether one of the multiple network connections that is different from the second network connection is to be selected for communication.

37. The method of claim 36, wherein the first message is broadcasted by the first UE via Vehicle-to-Vehicle (V2V) messaging over PC5.

38. The method of claim 36, wherein the step of determining whether one of the multiple network connections that is different from the second network connection is to be selected for communication comprises at least one of:
determining whether a location associated with the weak signal strength event is relevant to a route along which the second UE is travelling; and
determining whether the second network connection is currently in use by the second UE.

39. The method of claim 38, wherein the step of determining whether one of the multiple network connections that is different from the second network connection is to be selected for communication further comprises at least one of:
determining that one of the multiple network connections that is different from the second network connection is not to be selected for communication in response to determining that the location is not relevant to the route;
determining that one of the multiple network connections that is different from the second network connection is not to be selected for communication in response to determining that the second network connection is not currently in use by the second UE; and
determining that one of the multiple network connections that is different from the second network connection is to be selected for communication in response to determining that the location is relevant to the route and that the second network connection is currently in use by the second UE.

40. The method of claim 36, further comprising, in response to determining that one of the multiple network connections that is different from the second network connection is to be selected for communication, determining a distance between a current location of the second UE and a location indicated by the weak signal strength event.

41. The method of claim 40, further comprising:
determining, based on the determined distance, an estimated time of arrival (ETA) for the second UE to arrive at the location indicated by the weak signal strength event.

42. The method of claim 41, further comprising performing at least one of:
determining a first start time for a procedure to start preparing the selected network connection for communication based on at least the determined ETA; and
determining a second start time to start using the selected network connection for communication based on at least the determined ETA.

43. The method of claim 42, further comprising at least one of:
starting the procedure at the first start time; and
starting using the selected network connection at the second start time.

44. The method of claim 42, wherein the procedure comprises at least one of requesting for a Quality of Service (QoS) for the selected network connection, and steering traffic associated with the second UE to an Edge Application Server (EAS).

45. The method of claim 36, wherein receiving the first message comprises at least one of:
receiving the first message from the first UE via the second network connection;
receiving the first message from the first UE via the selected network connection; and
receiving the first message from the first UE via at least one of the multiple network connections other than the second network connection and the selected network connection.

46. The method of claim 36, wherein the weak signal strength event indicates one or more weak signal areas.

47. The method of claim 46, wherein for each of the one or more weak signal areas, the weak signal strength event indicates at least one of:
a location or location area where a weak signal is detected;
an identity (ID) of a Communication Service Provider (CSP) for which the weak signal is detected;
a Radio Access Type (RAT) associated with the detected weak signal; and
a signal strength of the detected weak signal.

48. The method of claim 36, wherein the first UE and the second UE are vehicles.

49. A method at a first UE for weak signal strength detecting and reporting, the method comprising:
detecting, as a weak signal strength event, that a signal strength of a first network connection of the first UE is lower than or equal to a threshold; and
in response to the detecting, transmitting a first message to a second UE, the first message indicating the weak signal strength event.

50. The method of claim 49, wherein the second UE has multiple network connections comprising a second network connection corresponding to the first network connection of the first UE.

51. The method of claim 49, wherein transmitting the first message comprises broadcasting the first message via V2V messaging over PC5.

52. The method of claim 51, wherein the first message is broadcasted periodically.

53. The method of claim 49, further comprising subsequently detecting that the signal strength of the first network connection becomes higher than the threshold.

54. The method of claim 53, further comprising determining a distance between a first location corresponding to detection of the weak signal event and a second location where the signal strength became higher than the threshold.

55. The of claim 54, wherein the first location is a location corresponding to a first detection of the weak signal strength event.

56. The of claim 54, wherein the second location is a location corresponding to a first time after detection of the weak signal strength event that the signal strength became higher than the threshold.

57. The method of claim 54, further comprising:
comparing the distance against a maximum broadcasting distance associated with the first UE,
wherein the step of transmitting the first message is performed only when the distance is shorter than or equal to the maximum broadcasting distance associated with the first UE.

58. The method of claim 49, wherein the first network connection is the only network connection of the first UE.

59. The method of claim 58, wherein the step of transmitting the first message is not performed until the signal strength is higher than the threshold.

60. A user equipment (UE) comprising:
a memory storing instructions; and
a processor operative to execute the instructions, whereby the processor causes the UE to:
evaluate information received via sidelink signaling from another UE, the information indicating a weak signal area as detected by the other UE with respect to a communication service provider; and
decide whether to change from an existing network connection associated with the communication service provider to another network connection not associated with the communication service provider, based on determining whether the weak signal area is relevant to a route of the UE.

61. A system comprising a first user equipment (UE) included in a first vehicle, and a second UE included in a second vehicle, wherein:
the first UE is configured to detect a weak signal area with respect to a first communication service provider and broadcast sideline information about the weak signal area, including a corresponding location and an identity of the first communication service provider; and
the second UE is configured to receive the broadcasted sidelink information and, responsive to determining that the weak signal area is relevant to a route of the second vehicle, change an existing network connection of the second UE from the first communication service provider to a second communication service provider.
